(19) United States
(12) Patent Application Publication
(10) Pub. No.: US 2017/0240375 A1
(43) Pub. Date: Aug. 24, 2017

(54) DUAL AXIS CUTTING SYSTEMS AND WEB FINISHING METHODS

(71) Applicant: John M. Nader, Valparaiso, IN (US)

(72) Inventor: John M. Nader, Valparaiso, IN (US)

(21) Appl. No.: 15/435,971

(22) Filed: Feb. 17, 2017

Related U.S. Application Data
(60) Provisional application No. 62/297,387, filed on Feb. 19, 2016.

(51) Int. Cl. B65H 35/08; B26D 1/20; B23K 26/08; B41J 11/70; B26F 3/00; B65H 35/02; B65H 5/24; B26D 1/62; B23K 26/38

(52) U.S. Cl. CPC B65H 35/08; B26D 1/626; B26D 1/205; B23K 26/0846; B23K 26/38; B26F 3/004; B65H 35/02; B65H 5/24; B41J 11/70; B23K 2203/40

(57) ABSTRACT

Cutting systems and methods capable of performing a variable cutting operation on a continuous web. The system includes a first cutting apparatus configured to receive the web and perform a cutting operation thereon to produce unfinished documents, and a second cutting apparatus configured to subsequently perform a trim cutting operation thereon to produce finished documents of selectively defined finished lengths, wherein the second cutting apparatus has a feed direction that is perpendicular to a feed direction of the first cutting apparatus. The system includes a conveyor system configured to receive the unfinished documents from the first cutting apparatus, arrange the unfinished documents into a stream of shingled documents traveling in the feed direction of the first cutting apparatus, and turn the unfinished documents at a right angle to travel in the feed direction of the second cutting apparatus without changing their orientation.

### CROSS REFERENCE TO RELATED APPLICATIONS

This application claims the benefit of U.S. Provisional Application No. 62/297,387, filed Feb. 19, 2016, the contents of which are incorporated herein by reference.

### BACKGROUND OF THE INVENTION

The present invention generally relates to equipment and processes used in the commercial printing industry. The invention particularly relates to equipment and processes for cutting to length various image sizes fed to the equipment on a continuous web.

Conventional commercial web offset printing is performed with rotary fixed-circumference (repeat) printing cylinders in combination with a rotary cutter. Conventionally, the circumference of a printing cylinder is wrapped with printing plates that contain multiple common-length images that are equally spaced around the circumference of the printing cylinder, and by which equally-spaced printed images are created on a web fed through the printing cylinder. The rotary cutter comprises a cutting or knife cylinder equipped with knives that are oriented parallel to the axis of the knife cylinder to cut the printed web against a hardened anvil cylinder as the printed web passes between the counter-rotating cylinders (“cutting couple”), producing finished products having the common-length printed images. The cutting couple of a rotary cutter designed to cut the individual printed images to length has the same circumference as the printing cylinder so that the surface speed of the knives matches the web speed of the printed web.

During a web-fed printing process, depending on desired final print product length of any particular job, relative same length image repeats are stepped and repeated in the web direction up or around the plate cylinder, where unlike multi-color print images at the corresponding head and foot of adjacent products meet. As used herein, the term job is used to refer to the production of a series of print products comprising certain specific print, and having a specific final product size. When print images are transferred to the web and subsequently cut off at final product size, it is not practical to use a single knife to separate an adjacent pair of print images at the precise meeting point of their corresponding head and foot. Therefore, the cutting of multi-color print images typically requires a double knife cut, known in the industry as a cross cut rotary “bleed trim,” which produces a waste “chip” that is discarded from the finished products via a waste extraction system, of which various types are known.

Unlike sheeter devices designed to cut off webs as single thickness pages, traditionally rotary bleed trimming in the cross web direction requires a knife cylinder having at least one but more often multiple sets of two consecutive knives, each set acting as a pair and positioned on the knife cylinder to exactly meet the running web at an appropriate surface speed and timing to create a double cross-cut bleed trim at the head and foot of each consecutive product and thereby separate individual products from the running web. The term “step” is used in the industry to refer to the precise physical distance a print image is repeated on a printed web. The step includes the sum of the actual image print length and the total length of the bleed trim, defining a physical distance for the image length to step prior to “repeating” itself within a finite rotary image cylinder circumference or within a fully infinite length without any predetermined step and repeat limitations (symmetrical bleed).

With traditional fixed-circumference offset printing plates and print lengths sized for the circumference of a printing cylinder or the overall size repeat of the printing press, the predeterminable step and repeat of a printed image is finite within the range of numbers of printed images (commonly one through five) that can be produced by a printing cylinder and accommodated by the rotary cutter set up to specifically match the image step and repeat of the printing cylinder. Finished image (product) lengths are adjustable within a limited range by the number of images on the circumference of the printing cylinder along with adjusting the chip size between printed images. Dividing the circumference in even angular slices to match the number of printed images per circumference along with chip size determines the angular placements of the knives on the knife cylinder. Changing the location of each knife holder on a knife cylinder to match the number of images and chip size between images from job to job requires considerable “make-ready” time, resulting in costly idle downtime of the finishing system.

Commercial printing is rapidly moving into the use of variable repeat print engines, particularly notable examples of which are digital inkjet printing technologies. Unlike conventional web offset printing using fixed-circumference printing cylinders, inkjet technologies offer virtually any image (product) length to be printed on demand based on the electronic print format input. In this case, a print image repeated on a printed web is referred to as a “document,” and a step includes the sum of the document print length and the length of the bleed trim within the length of web prior to the document being repeated. Certain inkjet technologies include a periodic purge of the ink jets, creating what has been referred to as a service bar that spans the width of the web and creates a non-symmetrical bleed. Such a purge typically occurs after the printing of several documents along a length of web, and the length of a service bar, for example, about 12 mm, must be accommodated by the printing process. The result may be termed a predetermined and semi-permanently fixed “frame” length that includes the sum of the document print lengths, the bleed trim lengths, and the service bar length that are all within a length of the web prior to the frame being repeated.

While variable repeat print technologies enable the document print length, step and frame length to be varied from job to job, they are limited by the make-ready requirements of conventional knife cylinders used to cut the individual digitally-printed products to length. Consequently, methods and equipment are needed that are capable of cutting variable equal length images and removing bleed waste between images, while also being more capable of accommodating the ability of variable repeat print technologies to vary document print length, step and frame length from job to job. This long standing traditional design rotary cutting couple using one pair of cylinders typically arranged vertically as knife and anvil date to the 1970's.

In the late 1990's newer designs for web finishing cutoff with bleed trim removal slowly emerged. One design utilizes two consecutive horizontally arranged cutting couples each using a single cross cut knife without repeat size reference to print image repeat or document length whereby one of the knifes is rotationally positioned to match a specific location to the print image document and another of the knives is located in a subsequent cutting couple and is phased advance or retard slightly relative to the previous knife to cut and thereby remove a bleed or chip. Both cutting heads can be speed corrected in unison to lengthen or shorten document size in order to match printed image length electronically or digitally produced. Significant limitations are experienced by users of these methods in the way of bleed chip removal effects speed performance as well as the ability to cut greater thicknesses or multiple pages from increasingly wider webs.

After around 2010, a technique emerged comprising rotary bleed trimming systems arranged in the in the cross web direction that required a knife cylinder having at least one set, but more often multiple sets, of two consecutive knives. Each set of knives acting as a pair and positioned on the knife cylinder to exactly meet the running web to create a double cross-cut bleed trim at the head and foot of each consecutive product and thereby separate individual products. The systems may include a preprogrammed algorithm of speed changes to create an electronic “camming” action of the cylinder cutting couples to selectively increase and decrease speed cylinders and knives to meet the position of variable length digitally produced documents without reference to repeat lengths of fixed cylinder produced images. However, significant performance limitations occur when optimal size documents are not being produced as well as limitations when cutting greater thickness paper and page counts.

In view of the above, there is an ongoing desire to improve cutting systems to adjust for varying document lengths when changing over from job to job.

### BRIEF DESCRIPTION OF THE INVENTION

The present invention provides a cutting system and method that are configured to produce finished documents from a running web during a web finishing process. The system and method may be particularly beneficial in relation to the latest non-cylindrical, non-fixed repeat production inkjet web printing systems capable of producing fully variable document lengths that may be selectively changed job to job on demand.

According to one aspect of the invention, a cutting system is configured to perform a variable cutting operation on a web. The system includes a first cutting apparatus configured to receive the web from a web printing system and perform an initial cutting operation on the web to produce a plurality of unfinished documents, and a second cutting apparatus configured to receive the plurality of unfinished documents and perform a trim cutting operation on each of the unfinished documents to produce finished documents of selectively defined finished lengths, wherein the second cutting apparatus has a feed direction that is perpendicular to a feed direction of the first cutting apparatus. The system further includes a conveyor system configured to receive the unfinished documents from the first cutting apparatus, arrange the unfinished documents into a stream of shingled documents traveling in the feed direction of the first cutting apparatus, turn the unfinished documents within the stream of shingled documents at a right angle such that the unfinished documents travels in the feed direction of the second cutting apparatus without changing the orientation of the unfinished documents, and feed the unfinished documents to the second cutting apparatus.

According to another aspect of the invention, a method of performing a variable rotary cutting operation on a web includes feeding the web through a first cutting apparatus in a feed direction of the first cutting apparatus to perform an initial cutting operation on the web and produce a plurality of unfinished documents, conveying the unfinished documents from the first cutting apparatus in the feed direction of the first cutting apparatus, arranging the unfinished documents into a stream of shingled documents traveling in the feed direction of the first cutting apparatus, turning the unfinished documents within the stream of shingled documents at a right angle so as to redirect the unfinished documents in a second feed direction that is perpendicular to the feed direction of the first cutting apparatus without changing the orientation of the unfinished documents, and feeding the unfinished documents through a second cutting apparatus to perform a trim cutting operation on each of the unfinished documents while traveling in the second feed direction to produce finished documents of selectively defined finished lengths.

Technical effects of the cutting system and method described above preferably include the capability of producing finished documents of varying lengths, including cutting variable equal length images and removing bleed waste between images, with reduced make-ready time as compared to conventional cutting systems and methods.

Other aspects and advantages of this invention will be further appreciated from the following detailed description.

### BRIEF DESCRIPTION OF THE DRAWINGS

FIGS. 1 and 2 represent two views of a dual axis cutting system that utilizes first and second cutting apparatuses and a conveyor system therebetween in accordance with a first nonlimiting embodiment of the invention.

FIGS. 3 and 4 represent the dual axis rotary system of FIGS. 1 and 2 during operation.

FIG. 5 represents a second nonlimiting embodiment of the first cutter of FIGS. 1 and 2 having a knife cylinder equipped with knives (not visible) that are oriented parallel to the axis of the knife cylinder and a nonlimiting embodiment of the second cutter of FIGS. 1 and 2, which in combination are suitable for use in a dual axis cutting system in accordance with certain nonlimiting aspects of the invention.

FIG. 6 is an isolated view of a third nonlimiting embodiment of the first cutter of FIGS. 1, 2, and 5.

FIGS. 7 and 8 are isolated views of various portions of the first cutter and conveyor system of FIGS. 1 and 2 during operation.

FIGS. 9 through 12 represent detailed views of various portions of a nonlimiting embodiment of the conveyor system of the dual axis cutting system of FIGS. 1 and 2.

FIGS. 13 and 14 are isolated views of various portions of the conveyor system and second cutter of FIGS. 1 and 2 during operation, from an entrance and exit travel direction, respectively.

FIGS. 15 and 16 are side views of two nonlimiting embodiments of rotary cutters suitable for use in the cutting system of FIGS. 1 and 2.

FIG. 17 represents a side view of the dual axis cutting system of FIGS. 1 and 2.

FIG. 18 represents exemplary individual documents produced in accordance with certain aspects of the invention in unfinished and finished states.

FIG. 19 is a plan view that represents a nonlimiting process performed by a dual axis cutting system in accordance with certain nonlimiting aspects of the invention.

FIG. 20 is an isolated view of the web, unfinished documents, and finished documents of products of FIG. 3.

FIGS. 21 through 23 representing various views of a dual axis cutting system that utilizes first and second cutting apparatuses and a conveyor system therebetween in accordance with a second nonlimiting embodiment of the invention

### DETAILED DESCRIPTION OF THE INVENTION

The present invention provides a dual axis cutting system and method that are configured to perform a final finished cut-off operation on a running web to create individual finished documents during a web finishing process, including print bleed trim removal at the head and foot of each document. The system and method are capable of performing a final finished cut-off to any “on demand” length that matches a pre-printed image and/or a document (length) cut-off from a continuous web exiting any type web press and/or web finishing system including but not limited to any inkjet/digital, offset, flexographic, or rotogravure system.

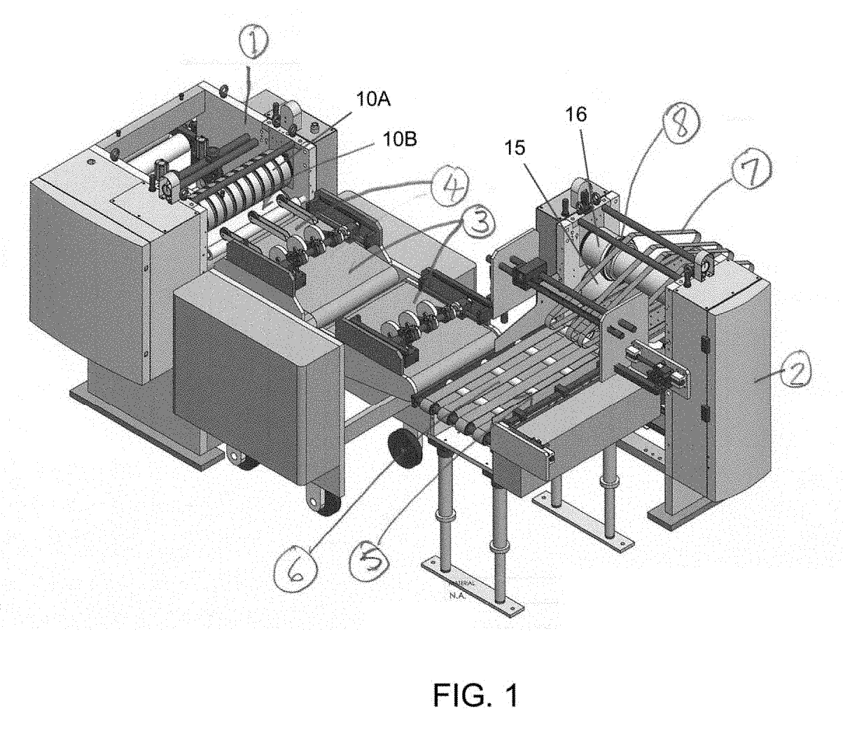

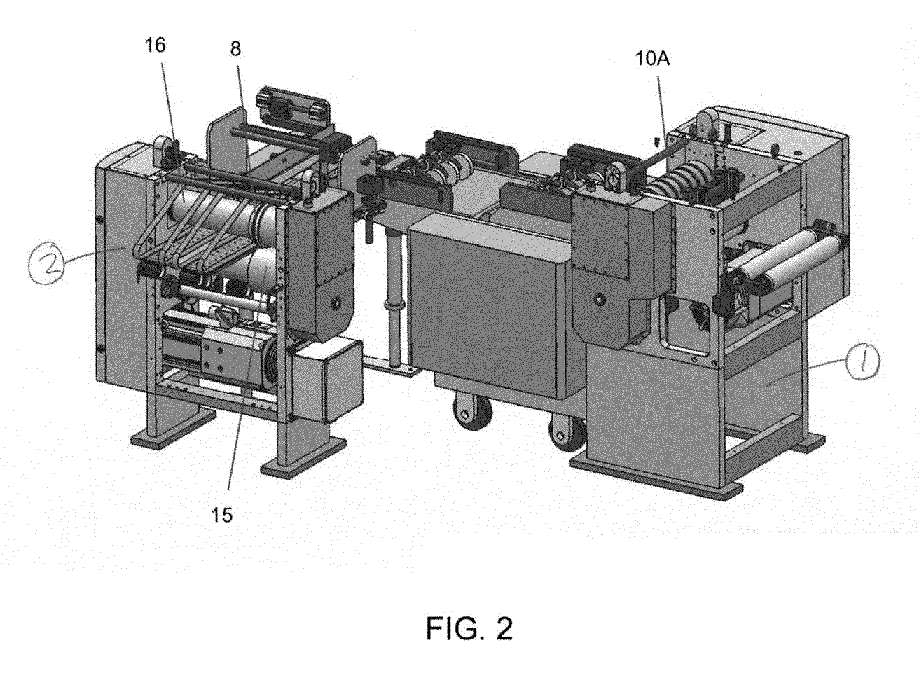

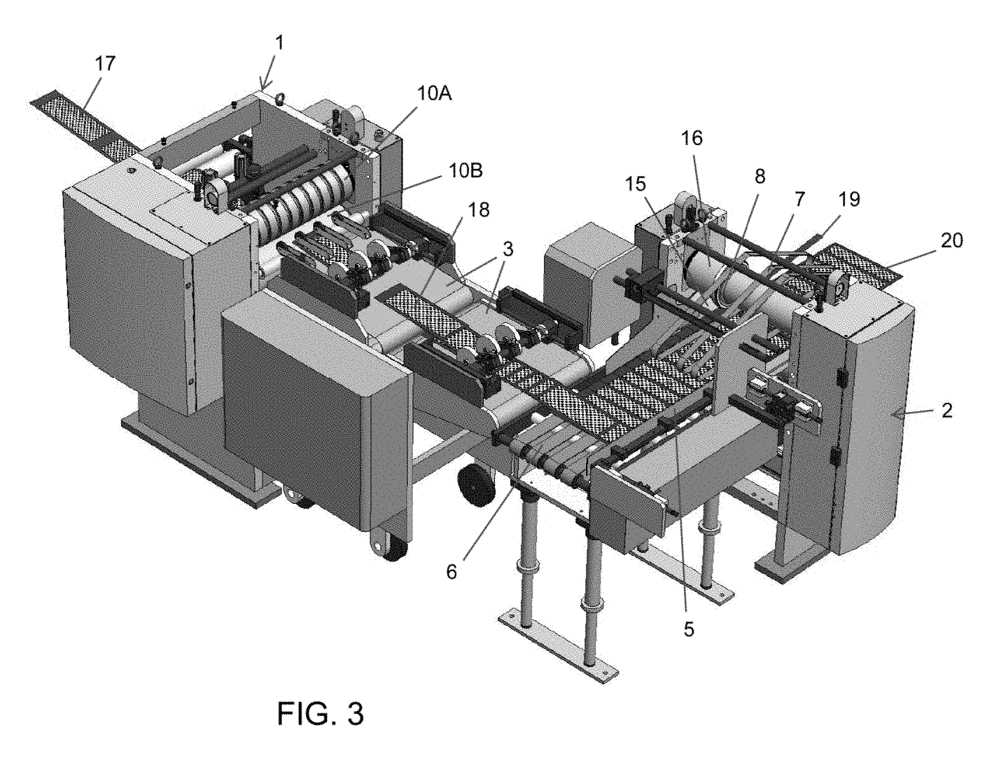

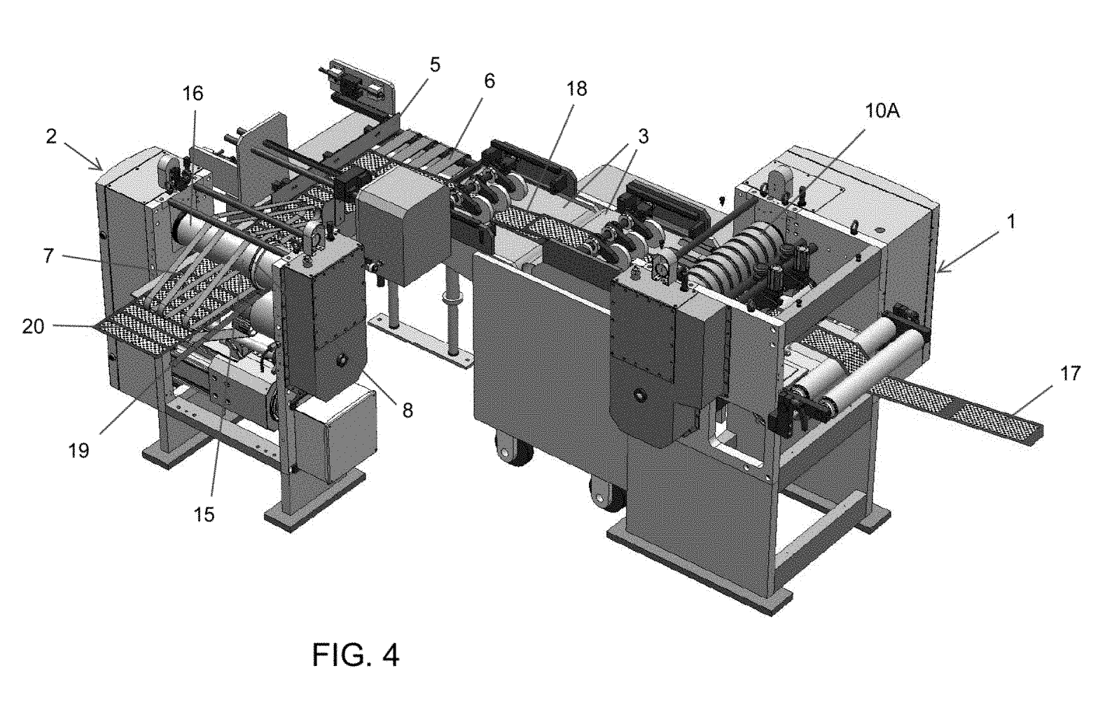

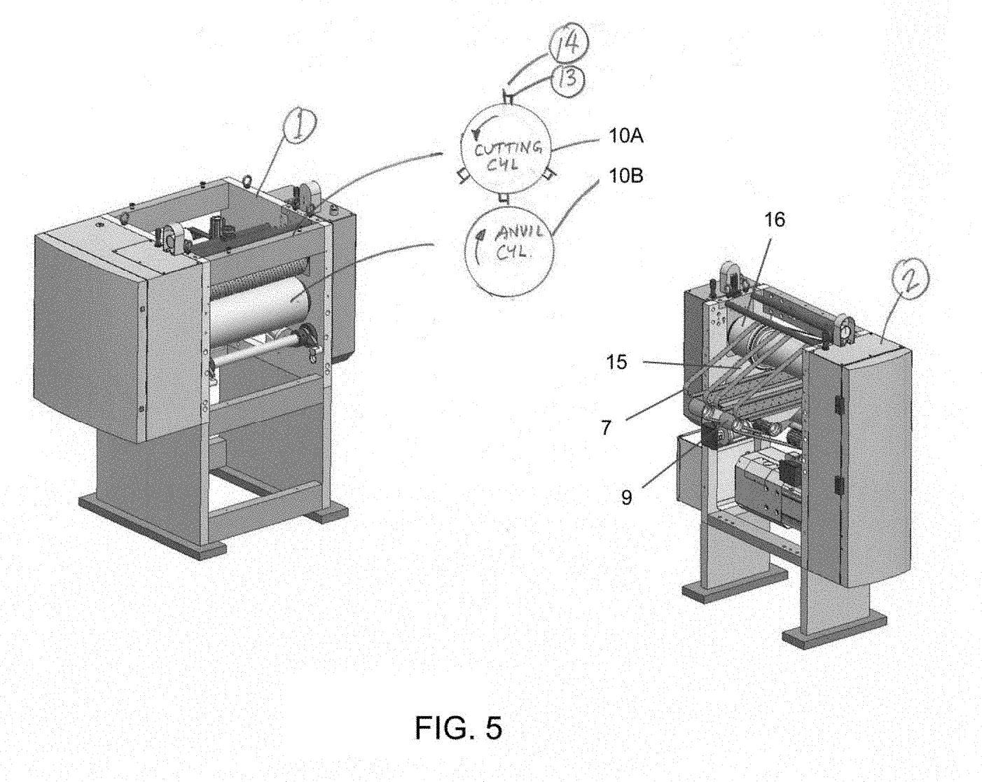

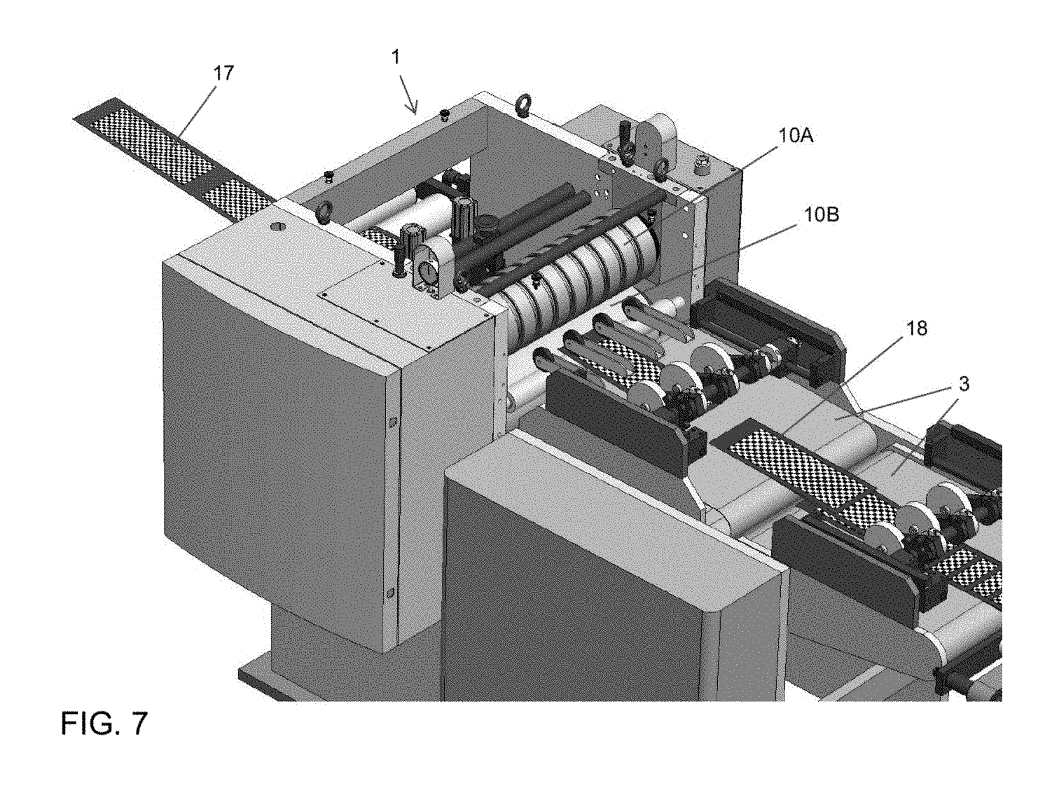

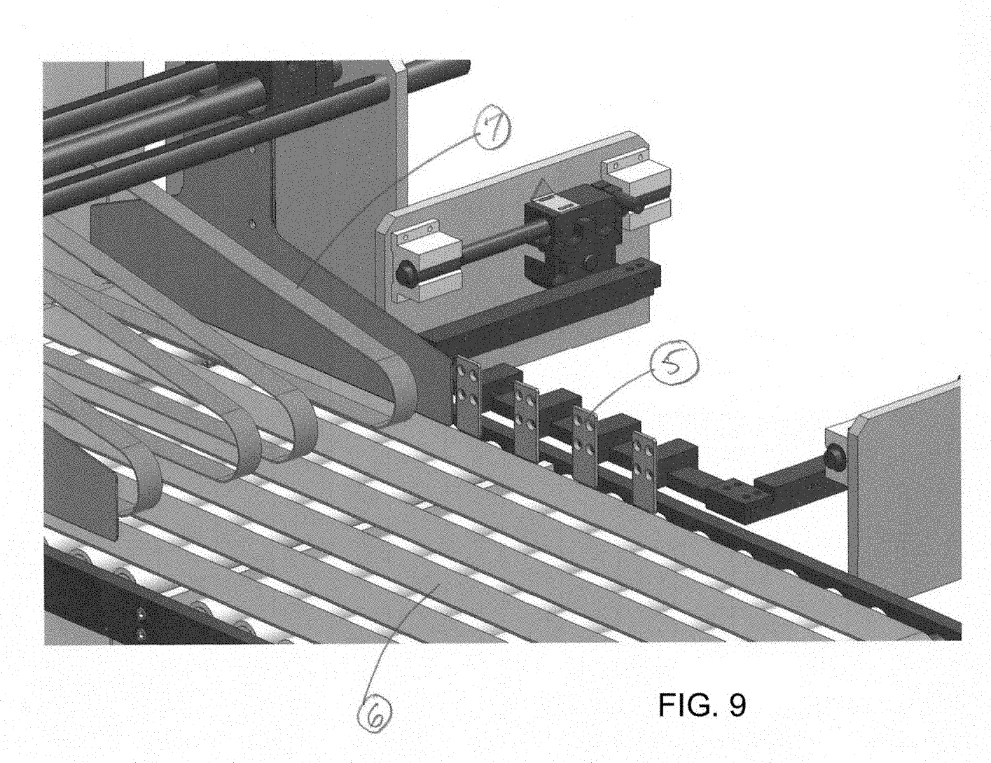

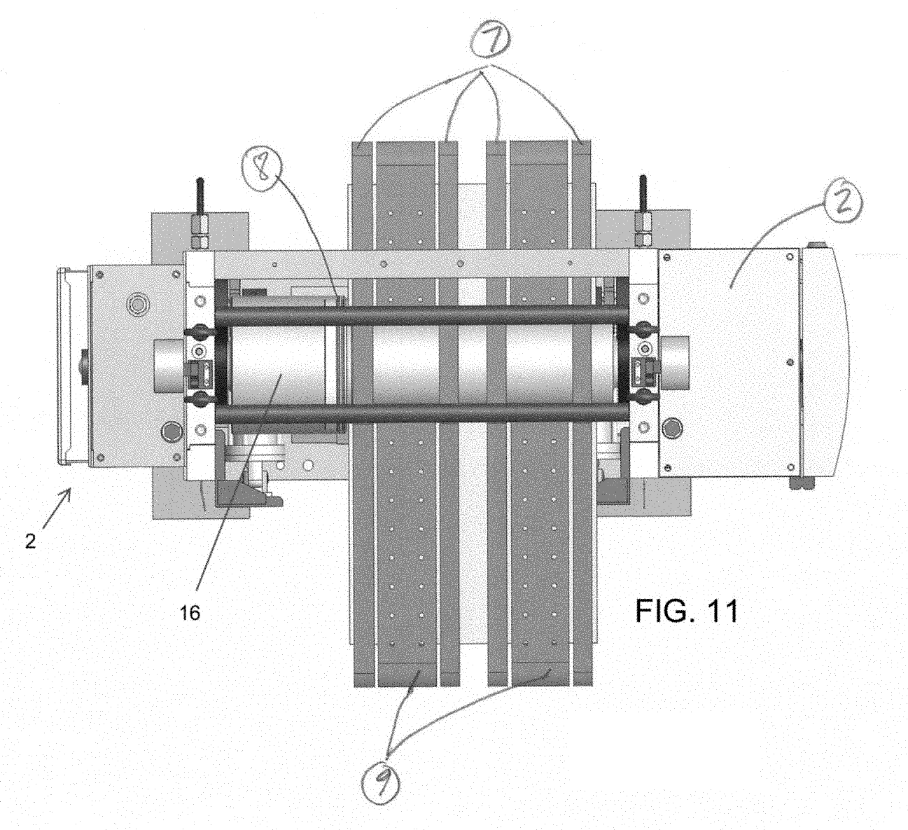

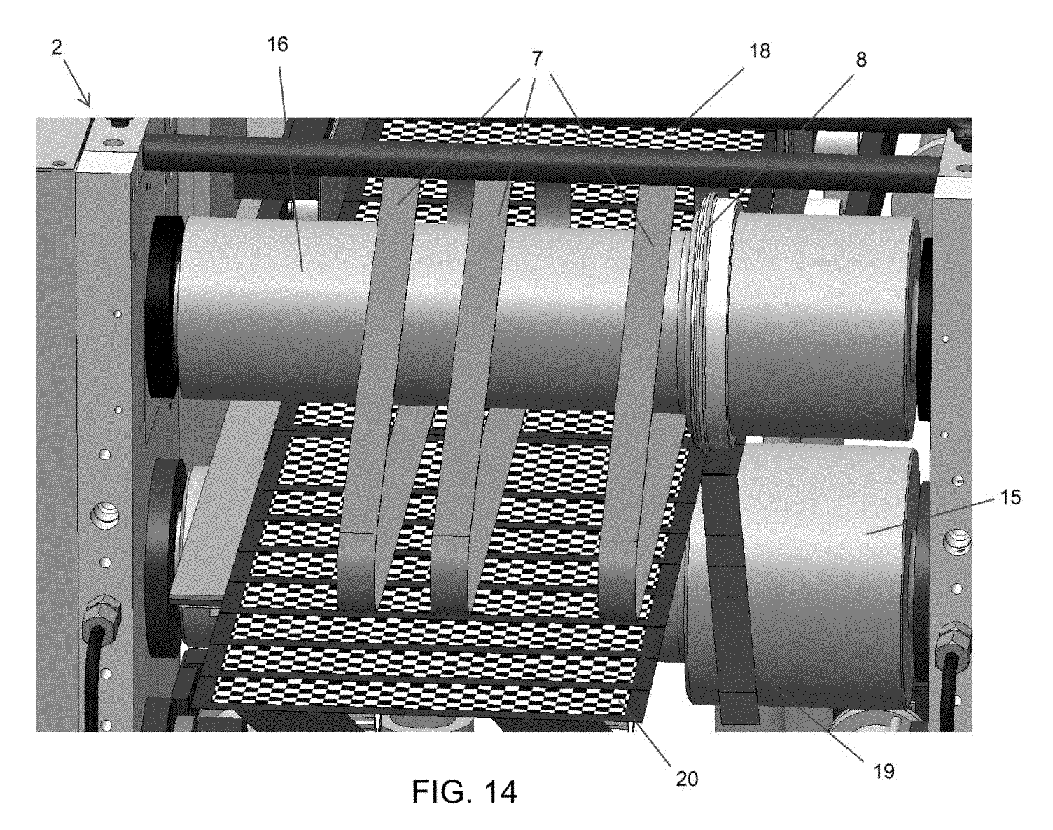

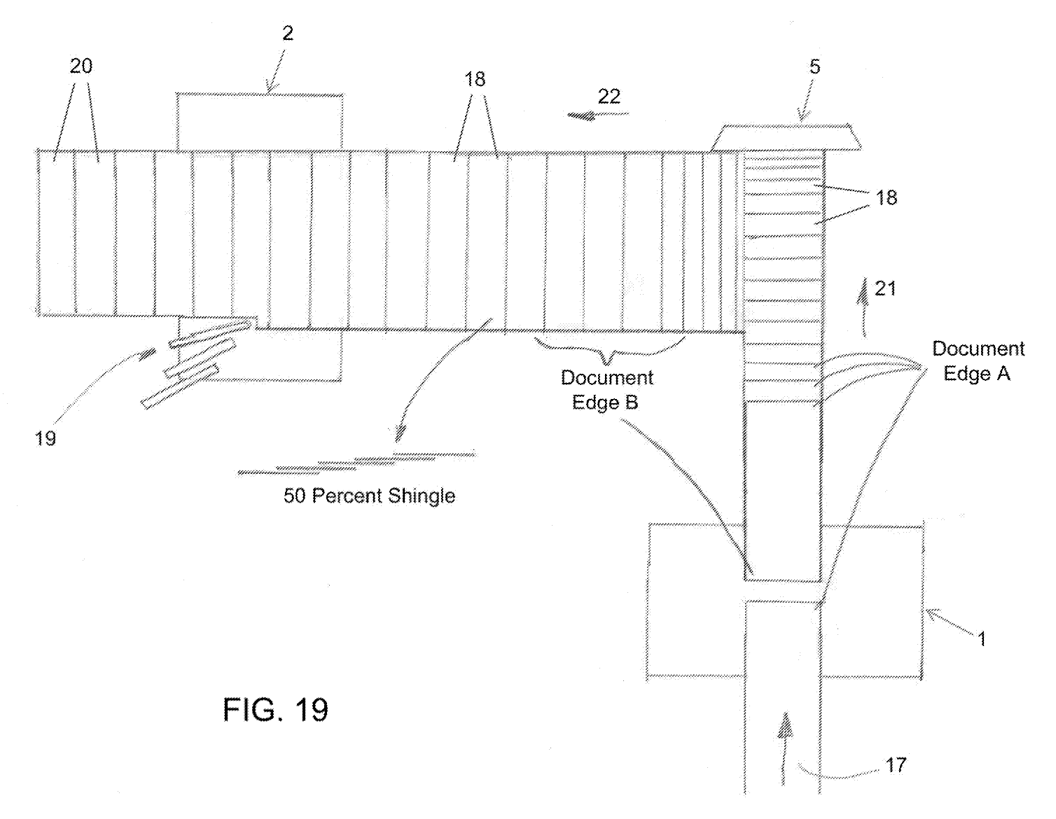

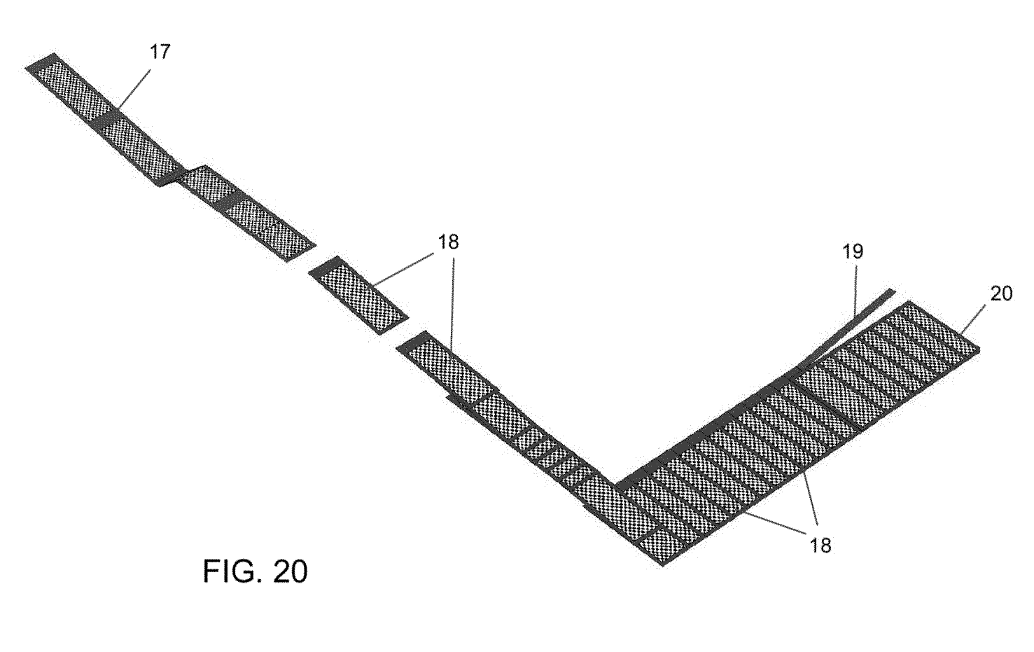

Nonlimiting examples of suitable dual axis cutting systems and components thereof are represented in FIG. 1 through 17, and 19. FIG. 1 schematically represents two isometric views of a dual axis cutting system in accordance with a first nonlimiting embodiment of the invention. FIGS. 5 through 17 and 19 represent such a system as including a first cutter 1, a second cutter 2, and a system of conveyors 3, 6, 7, and 9 therebetween. Preferably, the first cutter 1 includes a rotary cutting system. However, it is foreseeable that any suitable cutting system may be used for either the first or second cutter 1 and 2. In the nonlimiting embodiment of FIGS. 1 through 17, both of the first and second cutters 1 and 2 comprise rotary cutting systems. The first cutter 1 performs a first cut-off operation on a continuous preprinted web (e.g., the “incoming web” 17 shown in FIGS. 3, 4, 7, and 18 through 20) to create individual unfinished documents 18 (FIGS. 3, 4, 7, 8, and 18 through 20) and the second cutter 2 thereafter performs a finish trim operation on the individual documents 18 to produce finished documents 20 (FIGS. 3, 4, 13, 14, and 18 through 20). The first and second cutters 1 and 2 are positioned such that their feed directions 21 and 22 (FIG. 19) and, in the illustrated embodiments, the axes of their respective cylinders 10A, 10B, 15 and 16, are perpendicular to one another and both cutters 1 and 2 perform cutting action cross-grain to the paper orientation. This arrangement significantly reduces the make-ready time between individual jobs and is capable of being configured for automated, on-demand bleed trim size adjustments.

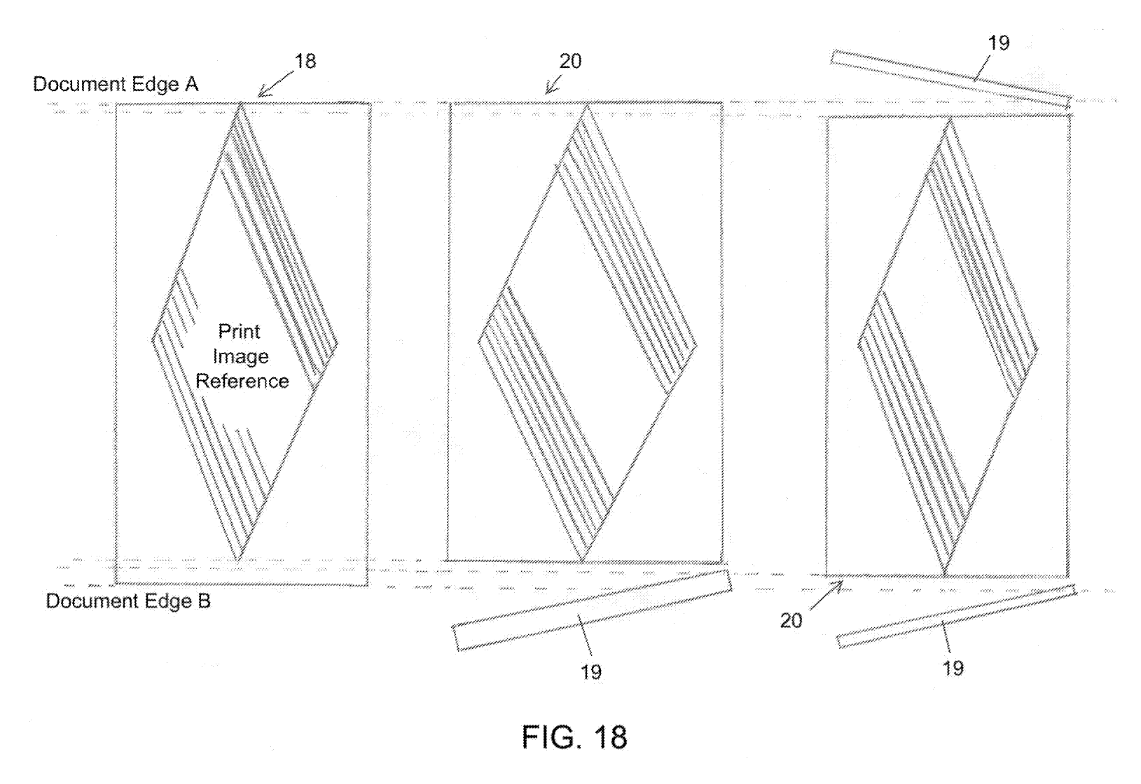

The first cutter 1, which comprises a cutting cylinder 10A and an opposing anvil cylinder 10B, may be used to perform a cross “chop/single” cut-off operation on a continuous preprinted web 17 at a finished position in reference to printed images on the web 17 and designated commonly as the “head or foot” of each unfinished document 18 (typically corresponding to image length). The image cut location (identified as edge A in FIGS. 18 and 19), may be crosscut to a gross length consistent to each unfinished document 18 with care taken to perform the cut as exact as possible at the head or foot of the unfinished document 18, thereby leaving each unfinished document 18 somewhat longer than the final finished size requirement of the finished document 20 at the opposite end (identified as edge B in FIGS. 18 and 19) of the unfinished document 18 and resulting in excess paper 19 (for example, non-imaged and/or bleed trim) remaining attached at the opposite end (edge B), as represented in FIGS. 3, 4, 13, 14, and 18 through 20.

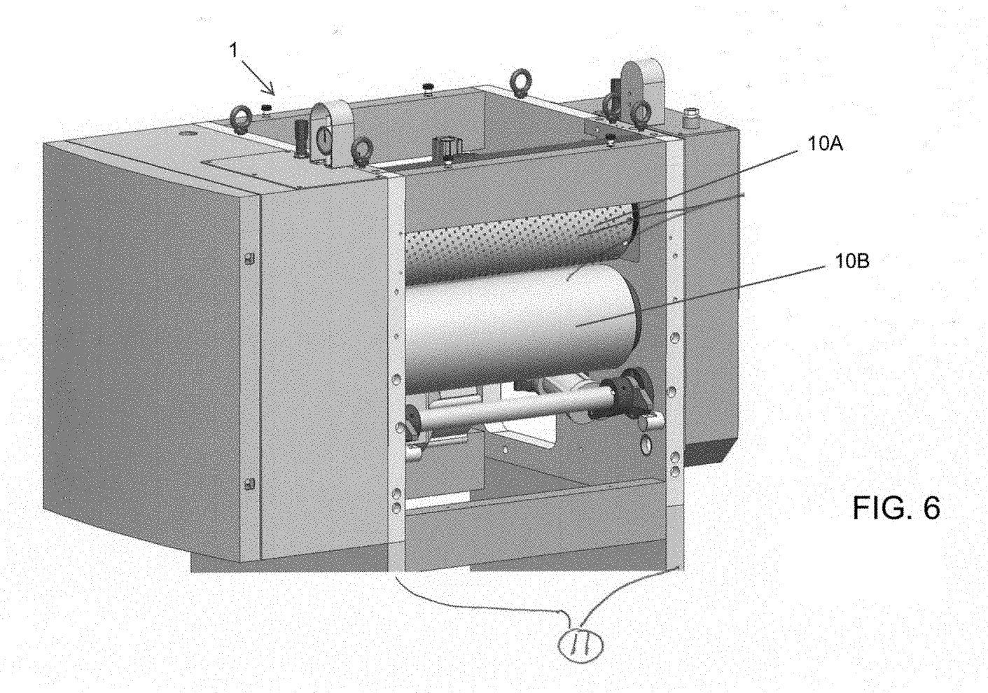

Gross document lengths may be quickly customized on make-ready at the first cutter 1 and are length variable from job to job by using combinations resulting from physical knife pre-indexed locations around the cutting cylinder 10A, by interchanging of knives 14 into or out of permanent or semi-permanently mounted knife holders 13, and by overspeed adjustments to the cylinders 10A and 10B, thereby matching the position(s) of the cylindrical knife 14 to desired cut positions of edges A or B of each image of the preprinted web 17 through constant velocity surface speed mismatch of the cylinders 10A and 10B to the web 17. Knife position(s) utilized around the circumference of the cutting cylinder 10A of the first cutter 1 may be software calculated and derived from operator input regarding desired final document size. Speed correction of the first cutter 1, if required, may also be software calculated based on the desired final document size. Preferably, single non-bleed cutting is performed only at the first cutter 1. The cutting cylinder 10A may be of any type known in the art suitable for performing the functions described herein. For example, FIGS. 5 and 6 represent the first cutter 1 as having a “honeycomb” knife blade mount cutting cylinder 10A and FIGS. 1 through 4 and 7 represented the first cutter 1 as having a “dovetail” type mechanical knife lock down cutting cylinder 10A.

During operation, newly cut-off individual unfinished documents 18 exiting the first cutter 1 will shingle atop one another consecutively at a location 4 on a variable speed conveyor(s) 3 to reduce surface speed as typical immediately following web cut-off (FIGS. 3, 4, 7, 8, 19, and 20). The stream of shingled unfinished documents 18 may be conveyed by the variable speed conveyor(s) 3 into a customized right angle “bump turn” conveyor system where the leading edge A (foot) of each unfinished document 18 will “jog” into alignment by way of a document length adjustable head stop 5, that is, the unfinished documents 18 will be traveling in a perpendicular direction to the original infeed direction without changing the orientation of the unfinished documents 18 relative to the print thereon. The stream of shingled unfinished documents 18 will preferably immediately cease from its initial travel (feed) direction 21 (associated with the first cutter 1) and commence a right angle turn and travel on a secondary table conveyor 6 to the second cutter 2 which performs the finish trim on each individual unfinished document 18 as it travels in a feed direction 22 that is perpendicular to the prior feed direction 21. For example, in reference to FIGS. 1 through 4, the variable speed conveyors 3 are specifically located at a higher elevation than the secondary table conveyor 6. During operation, the unfinished documents 18 propel through the air from the variable speed conveyors 3, strike the head stop 5, and then land on the secondary table conveyor 6. In order to obtain a desired shingle spacing of the unfinished documents 18 on the secondary table conveyor 6, the conveyors 3 and 6 may be at different operating speeds. For example, the speed of the conveyor 6 may be set at a predetermined speed in order to obtain a fifty percent conveyance shingling of the unfinished documents 18. If the first cutter 1 initially cuts a document 18 such that either edge A or edge B was as close as possible to the cut, the opposite edge of the document 18 may be cut by the second cutter 2 such that a final finished edge is formed on such edge for consistency and process simplification (FIG. 18). Alternatively, if the cut at the first cutter 1 was positioned to intentionally leave bleed area on both edges A and B, then both edges A and B may be trimmed at the second cutter 2 (FIG. 18).

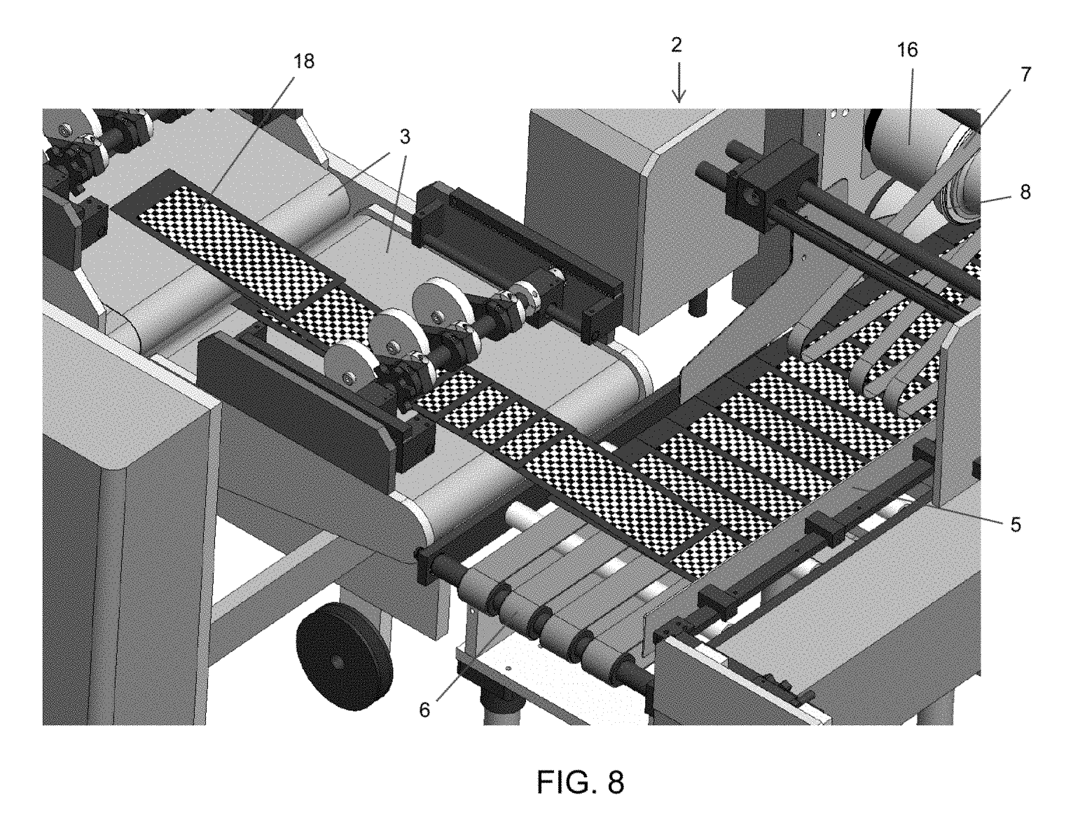

The customized right angle conveyor system may utilize side jogging, air floatation, vibration, static induction, and/or any other known techniques to ensure stream alignment quality. Preferably, the secondary table conveyor 6 is precisely velocity timed to spread the individual unfinished documents 18 to achieve an approximately 50 percent shingle (or shingle adjusted as necessary) to distribute the spacing of the unfinished documents 18 with regard to one another in order to equally distribute document thickness immediately after the stream of documents 18 is bump turned and jogged, and prior to entry into a motorized vacuum table belt conveyor 9 that leads into the second cutter 2 (FIGS. 8, 19, and 20).

Upon exiting the secondary table conveyor 6, the unfinished documents 18 enter and are conveyed along the vacuum table conveyor 9 with the assistance of a continuous driven tape conveyor 7. Consequently, the documents 18 are trapped and held in place flat against the vacuum table conveyor 9 immediately after product shingle stream spacing has been be accomplished.

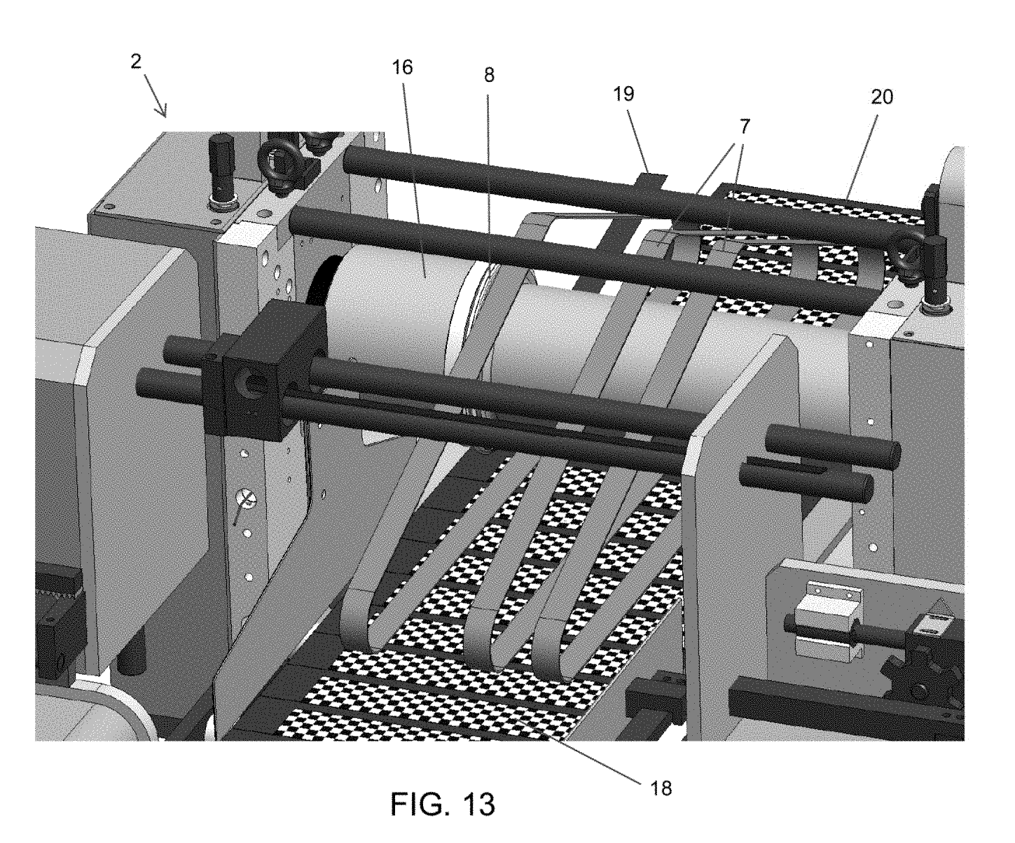

At this point, the unfinished documents 18 may enter the second cutter 2 for finish trimming. Preferably, the second cutter 2 is timed for surface speed to match a surface speed of the vacuum table conveyor 9 as well as the driven tape conveyor 7. Unlike the crosscut knives 14 mounted to the cutting cylinder 10A of the first cutter 1, the second cutter 2 preferably includes one or more rotary knives 8, for example, mounted clamshell or sleeve style, to completely around the circumference of the cutting cylinder 16 in order to remove the excess paper 19 by cutting the non-trimmed edge or edges of each document 18 to a finished final size. This setup provides for removal of non-image or bleed trim while in stream. Preferably, the second cutter 2 is configured to bleed trim the documents 18 on edge A only, edge B only (as shown in FIGS. 13, 14, 19, and 20), or both simultaneously within the second cutter 2.

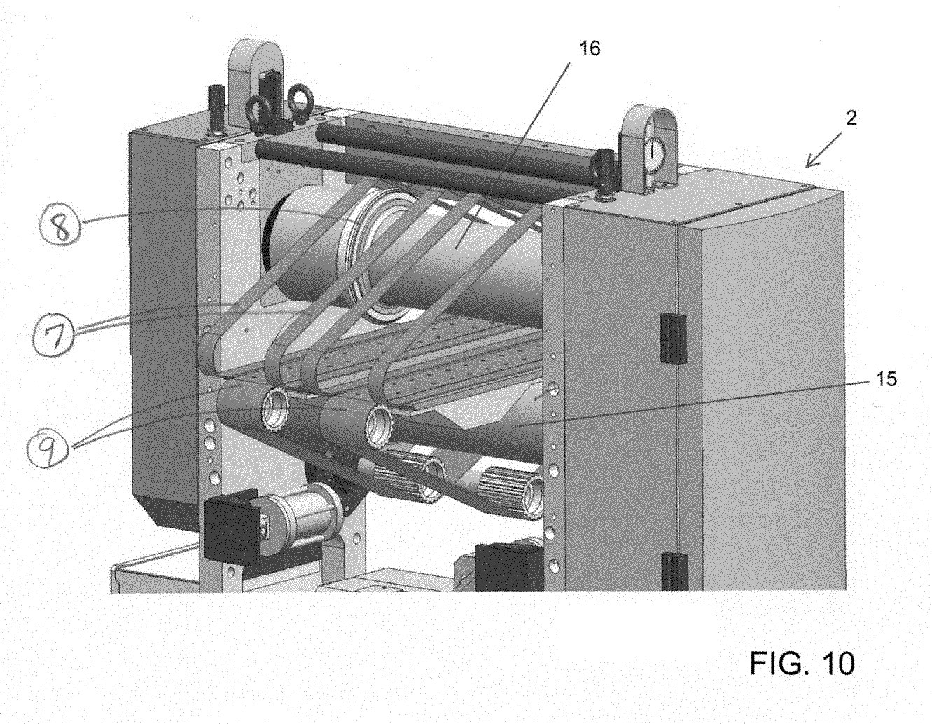

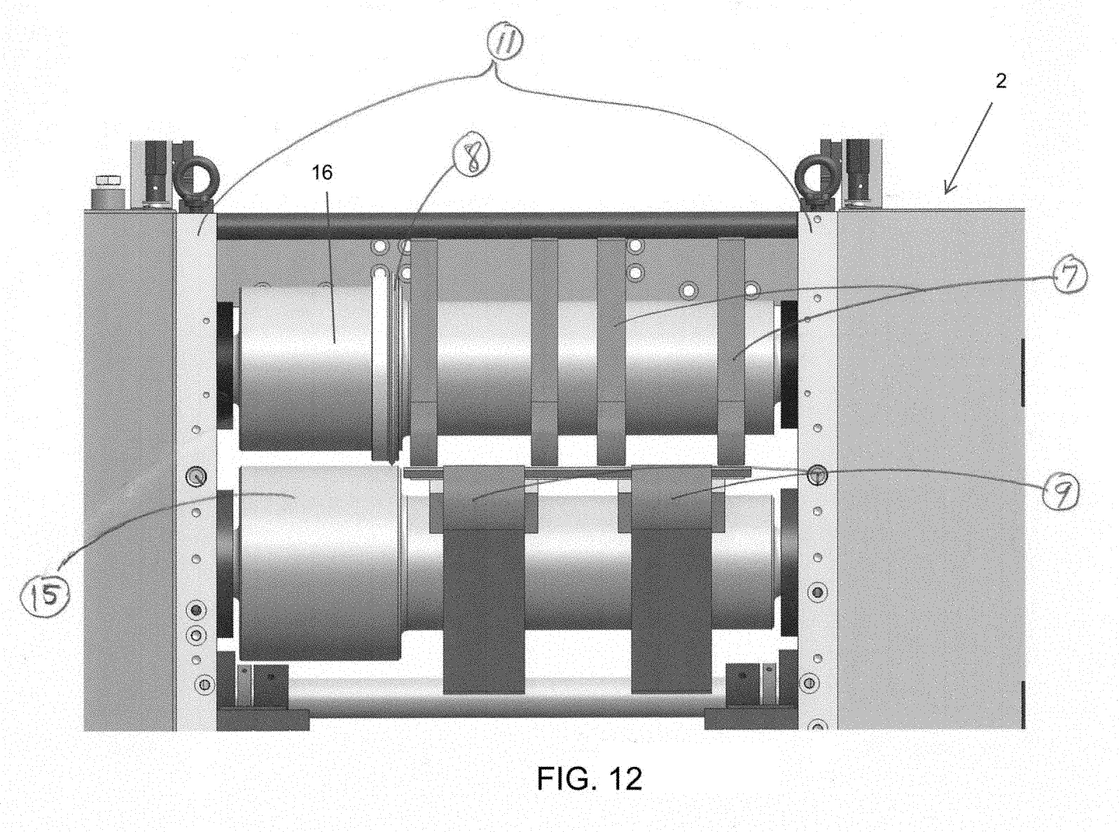

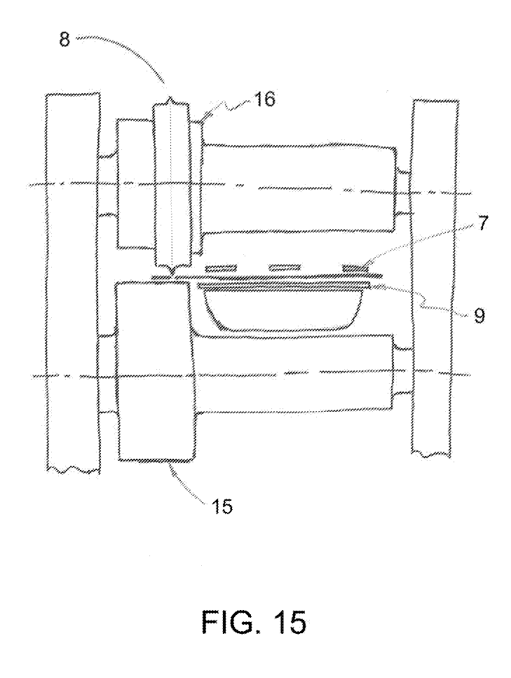

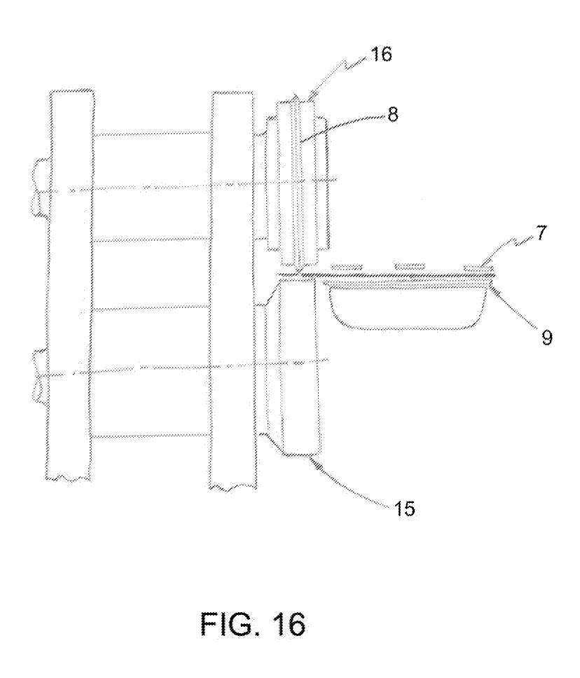

If using rotary cutting in for the second cutter 2, an anvil cylinder 15 of the second cutter 2, located below the cutting (knife) cylinder 16 may be “full width” 11 (FIG. 6) across a majority of the width of the second cutter 2, or may be “segmented” to be a partial width (FIG. 12) of the second cutter 2 as shown in FIGS. 12, 14, 15 and 16. The anvil cylinder 15 may optionally utilize an internal “vacuum” system to continue conveyance of the documents 18 while holding the documents 18 flat against the anvil cylinder 15. This provides for the documents 18 to be held continuously as they travel to, through, between, and from the anvil and cutting cylinders 15 and 16 of the second cutter 2, thereby securing the documents 18 while cutting takes place and promoting cut location stability and quality. If a full width anvil cylinder 15 is used, the vacuum table conveyor 9 may be split to terminate immediately at a point of physical incursion with an entry side of anvil cylinder 15 and commence again at an exit side of anvil cylinder 15. If a segmented anvil cylinder 15 is used, the vacuum table conveyor 9 may continue between the anvil and cutting cylinders 15 and 16 as best seen in FIG. 10. Regardless of lower conveyance design, anvil cylinder width, or internal vacuum of cylinder design, the driven tape conveyor 7 may be continuous through and between the anvil and cutting cylinders 15 and 16. FIGS. 15 and 16 are side views representing nonlimiting examples of the anvil and cutting cylinders 15 and 16, wherein the cylinders 15/16 are entirely within a frame of the second cutter 2, or cantilevered from the frame, respectively. Both arrangements represent the anvil cylinder 15 as being segmented such that its working surface only extends a partial width of the entire cylinder 15.

Preferably, the conveyor 6 utilizes a vacuum table for lower conveyance of the shingled stream and uses the driven tape conveyor 7 for upper driven conveyance to fully secure the documents 18 in the shingled stream to the conveyor 6 eliminating or reducing document slippage into and throughout second cutter 2. Furthermore, the vacuum table may be configured so as a vacuum pressure can be increased gradually or systematically in the conveyor direction towards the second cutter 2, for example, commencing only after jogging has concluded with desired side jog and shingle spacing of document stream after right angle turn. The conveyors 6 and 7 and vacuum pressure thereof may be optically and/or sensor controlled with closed loop fed back into motor drive systems PLC for continuous adjustment of document stream prior and throughout the second cutter 2. For example, optics or other sensors may be used to monitor the documents 18 (for example, the shingle spacing), a location where the jog process is complete may be determined based on the readings of these sensors, and then the vacuum table may be controlled to apply vacuum pressure (or increase the pressure) after the location where the jog process is completed.

Preferably, the second cutter 2 is capable of physically oscillating one or both of the anvil and cutting cylinders 15 and 16 as desired to evenly distribute wear of the anvil and cutting cylinders 15 and 16. In addition, the system preferably is capable of lateral movement of the secondary table conveyor 6, the vacuum table conveyor 9, the head stop 5 or any other component of the system to laterally adjust or register the documents 18 to the second cutter 2, the second cutter 2 to the documents 18, and/or the anvil and cutting cylinders 15 and 16 to one another.

The above described combination of the driven tape conveyor 7 above the documents 18, the vacuum table conveyor 9 below the documents 18, and anvil and cutting cylinders 15 and 16 provides for the ability to perform final bleed trim cut and waste trim removal to create to finished individually printed documents 20 to specific finished sizes all while the unfinished and finished documents 18 and 20 remain in a shingled stream state. Trim “bleed” waste may be immediately removed as scrap after cutting is performed by the second cutter 2. Thereafter, the finished documents 20 may be conveyed into a stacker, mailing, or manual packaging system. Both finished edges A and B of the finished documents 20 may be contour (shaped/sculpted) cut at as desired by adding or changing the cutting knives 14 and 8 of one or both of the first and second cutters 1 and 2. Preferably, each pair of cylinders 10A/10B and 15/16 utilizes axial (sidelay) and circumferential registration methods as deemed necessary to expedite operation and accuracy control. According to a nonlimiting aspect of the invention, the system may adjust bleed trim size on demand by either manually or automatically laterally tracking the running shingled stream of unfinished documents 18 and then positioning the stream and/or the anvil and cutting cylinders 15 and 16 individually or together.

Preferably, the system includes continuous optical proximity sensor(s), camera(s), and/or scanner-based sensor(s) that provide closed loop feedback and an associated hardware and/or software interface to a programmable logic controller (PLC) for measurement of document shingle spacing and adjustment of one or more motors, drives, and/or controllers for velocity and position control of the system of conveyors 3, 6, 7, and 9 and the second cutter 2.

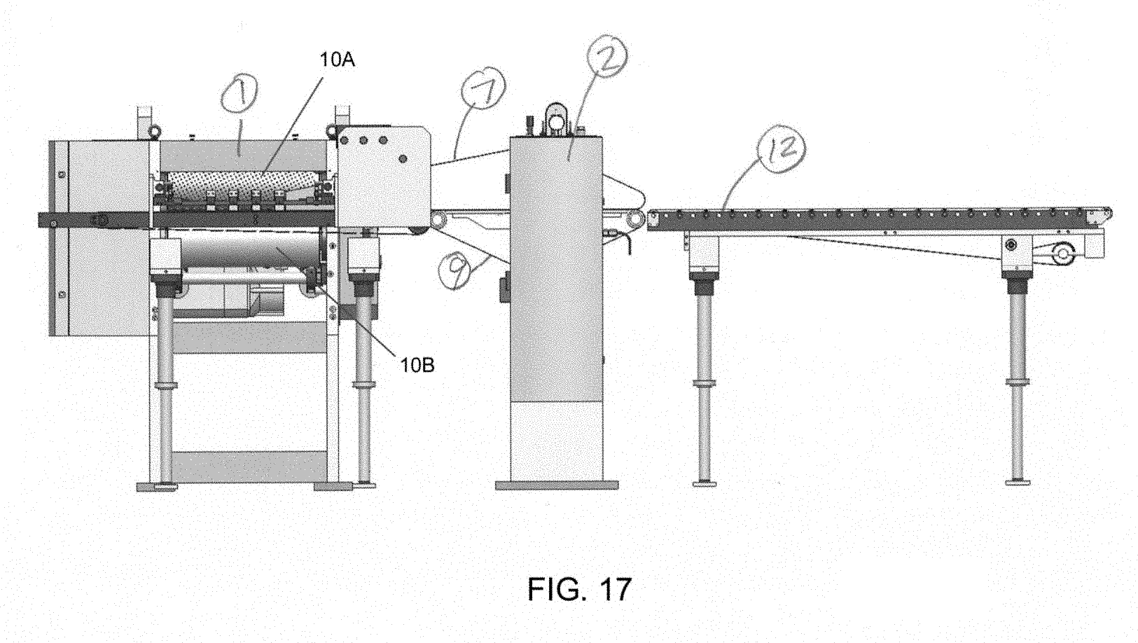

In view of the above, the system as described herein provides conveyor systems (vacuum systems optional) suitable for in and out feeding of a stream of precut, individual, gross sized preprinted documents to and from a specifically designed second cutter 2 for cylinder-to-cylinder, rotary, crush-style die cutting to final trim individual preprinted documents 20 having individually specific finished sizes while in a shingled stream state within a single continuous process. While the documents 20 are referred to herein as “finished,” it should be understood that such documents 20 may undergo additional processing after exiting the secondary cutter 2. For example, the documents 20 may continue to travel on a conveyor 12 (FIG. 17) to additional processing stations such as but not limited to a shingling station (not shown) that performs shingled delivery stacking of the documents 20 to provide a general postal sorting requirement.

While the system is shown as comprising certain specific components, it is foreseeable that functionally-equivalent components could be used to perform the final finished cut-off of the web 17. For example, the second cutter 2 having the steel-to-steel anvil and cutting cylinders 15 and 16 may be replaced with a shear type, laser, water jet, or reciprocating platen type cutting system suitable for performing the finish bleed trimming of the unfinished documents 18. In addition, the drawings disclose certain dimensions, materials, and processes for the various components of the system that are believed to be preferred or exemplary, but are otherwise not necessarily limitations to the scope of the invention.

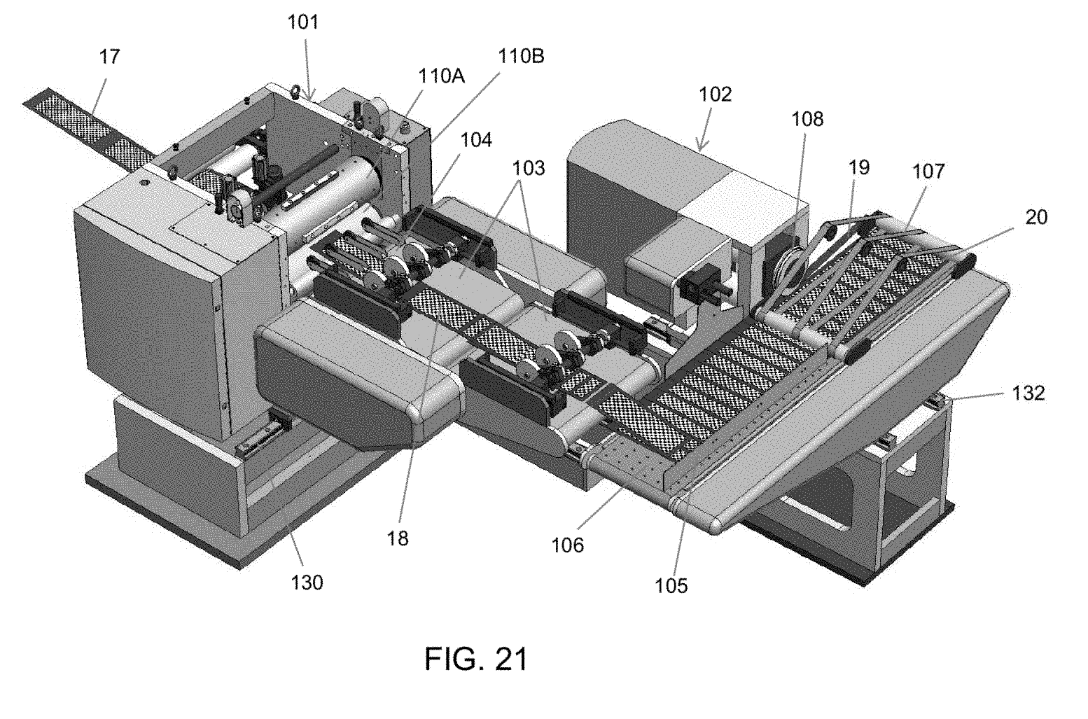

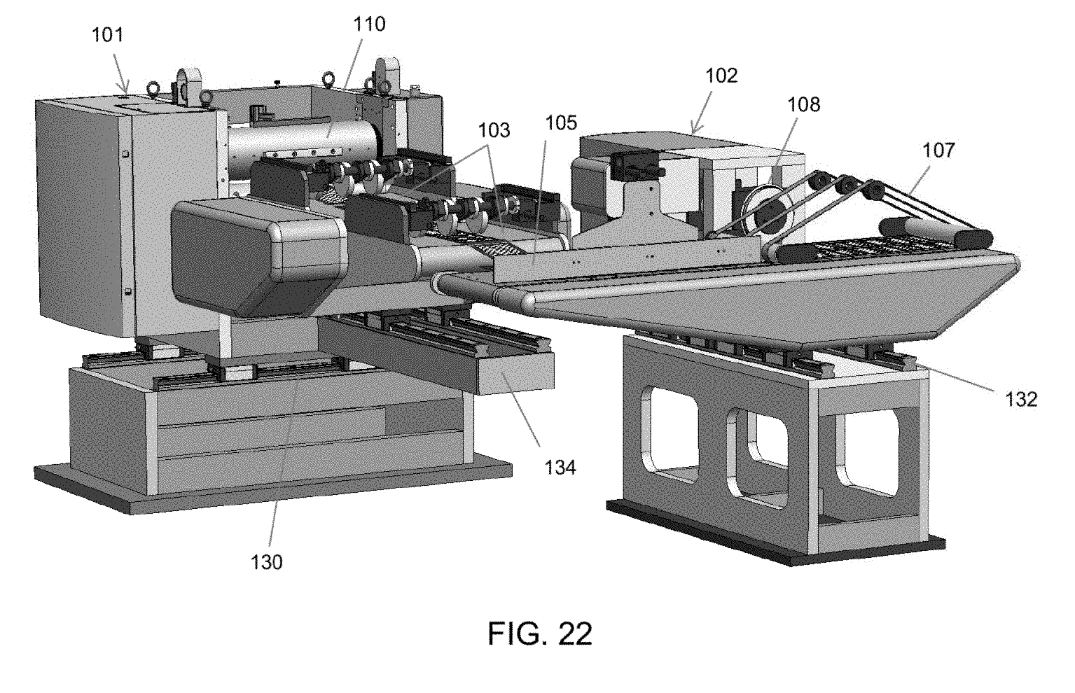

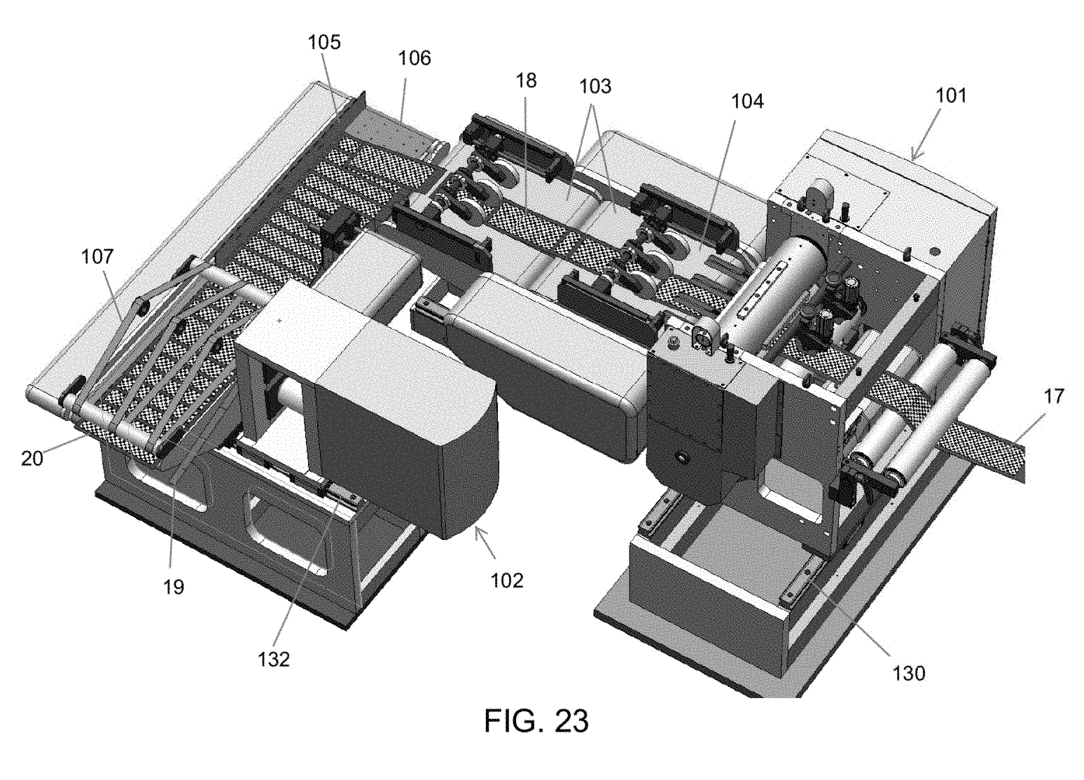

FIGS. 21 through 23 depict additional nonlimiting configurations of dual axis cutting systems and components thereof in accordance with further embodiments of this invention. In these figures, consistent reference numbers are used to identify the same or functionally related/equivalent elements, but with a numerical prefix (1, 2, or 3, etc.) added to distinguish the particular embodiment from the embodiment of FIGS. 1 through 17. In view of similarities between the first and second embodiments, the following discussion of FIGS. 21 through 23 will focus primarily on aspects of the second embodiment that differ from the first embodiment in some notable or significant manner. Other aspects of the second embodiment not discussed in any detail can be, in terms of structure, function, materials, etc., essentially as was described for the first embodiment.

The system of FIGS. 21 through 23 includes a first cutter 101, a second cutter 102, and a system of conveyors 103, 106, and 107 therebetween. Similar to the first embodiment, both of the first and second cutters 101 and 102 are represented as comprising rotary cutting systems. However, it is foreseeable that any suitable cutting system may be used for either the first or second cutter 101 and 102. The first cutter 101 performs a first cut-off operation on a continuous preprinted web (e.g., the “incoming web” 17) to create individual unfinished documents 18 and the second cutter 102 thereafter performs a finish trim operation on the individual documents 18 to produce finished documents 20.

The first and second cutters 101 and 102, and system of conveyors 103, 106, and 107 therebetween are supported on bases that include track systems 130, 132, and 134. A first track system 130 is configured to move the first cutter 101 and the conveyors 103 in lateral directions perpendicular to the direction of travel of the web 17. A second track system 132 is configured to move the second cutter 102 and the conveyors 106 and 107, and the adjustable head stop 105 in lateral directions perpendicular to the direction of travel of the finished documents 20. A third track system 134 is configured to move the first cutter 101 and the conveyors 103 in directions along the direction of travel of the web 17. Consequently, the track systems 130, 132, and 134 may be used to position the first and second cutters 101 and 102 and the conveyors 103, 106, and 107 relative to one another. It is within the scope of the invention that the system may include additional or fewer track systems, and that the track systems may be configured to position individual components or groups of components of the system relative to one another.

Therefore, while the invention has been described in terms of specific or particular embodiments, it is apparent that other forms could be adopted by one skilled in the art. For example, the system and/or its components could differ in appearance and construction from the embodiments described herein and shown in the drawings, and functions of certain components of the system could be performed by components of different construction but capable of a similar (though not necessarily equivalent) function. In addition, the invention encompasses additional or alternative embodiments in which one or more features or aspects of the different disclosed embodiments may be combined. Accordingly, it should be understood that the invention is not limited to any embodiment described herein or illustrated in the drawings. It should also be understood that the phraseology and terminology employed above are for the purpose of describing the disclosed embodiments, and do not necessarily serve as limitations to the scope of the invention. Therefore, the scope of the invention is to be limited only by the following claims.

1. A cutting system configured to perform a variable cutting operation on a continuous web, the cutting system comprising:
a first cutting apparatus configured to receive the web from a web printing system and perform an initial cutting operation on the web to produce a plurality of unfinished documents;
a second cutting apparatus configured to receive the unfinished documents and perform a trim cutting operation on each of the unfinished documents to produce finished documents of selectively defined finished lengths, the second cutting apparatus having a feed direction that is perpendicular to a feed direction of the first cutting apparatus; and
a conveyor system configured to receive the unfinished documents from the first cutting apparatus, arrange the unfinished documents into a stream of shingled documents traveling in the feed direction of the first cutting apparatus, turn the unfinished documents within the stream of shingled documents at a right angle such that the unfinished documents travel in the feed direction of the second cutting apparatus without changing the orientation of the unfinished documents, and feed the unfinished documents to the second cutting apparatus.

2. The cutting system of claim 1, wherein the web has print thereon applied by the web printing system, the web printing system comprising an inkjet web fed printing press.

3. The cutting system of claim 1, further comprising means for varying the length of the plurality of unfinished documents produced by the initial cutting operation on the web.

4. The cutting system of claim 1, wherein the plurality of unfinished documents produced by the initial cutting operation on the web have varying lengths corresponding to varying lengths of print applied thereon by the web printing system.

5. The cutting system of claim 1, wherein the conveyor system comprises means for closed loop feedback of measurement of a spacing overlap of the unfinished documents in the stream of shingled documents and means for adjustment of velocity and/or position of at least one conveyor of the conveyor system or the second cutting apparatus to adjust the spacing.

6. The cutting system of claim 1, wherein the conveyor system has means for controlling a speed of the unfinished documents to produce a predetermined spacing overlap between the unfinished documents in the stream of shingled documents.

7. The cutting system of claim 1, wherein the first and second cutting apparatuses use different types of cutting systems, wherein the first cutting apparatus performs a cross cut operation and the second cutting apparatus performs a trim cut operation.

8. The cutting system of claim 7, wherein the different types of cutting systems are chosen from the group consisting of rotary, reciprocating platen, laser, and water jet cutting systems.

9. The cutting system of claim 1, wherein the first cutting apparatus comprises a rotary cutting system.

10. The cutting system of claim 1, wherein the conveyor system includes means for producing a predetermined spacing overlap between the unfinished documents in the stream of shingled documents, means for measurement of the spacing overlap, and means for applying a vacuum pressure to the unfinished documents in the stream of shingled documents after the predetermined spacing overlap has been achieved and during the trim cutting operation.

11. A method of performing a variable cutting operation on a continuous web, the method comprising:
feeding the web through a first cutting apparatus in a feed direction of the first cutting apparatus to perform an initial cross cutting operation on the web and produce a plurality of unfinished documents;
conveying the unfinished documents from the first cutting apparatus in the feed direction of the first cutting apparatus;
arranging the unfinished documents into a stream of shingled documents traveling in the feed direction of the first cutting apparatus;
turning the unfinished documents within the stream of shingled documents at a right angle so as to redirect the unfinished documents in a second feed direction that is perpendicular to the feed direction of the first cutting apparatus without changing the orientation of the unfinished documents; and then
feeding the unfinished documents through a second cutting apparatus to perform a trim cutting operation on each of the unfinished documents while traveling in the second feed direction to produce finished documents of selectively defined finished lengths.

12. The method of claim 11, wherein the first cutting apparatus comprises a rotary cutting system.

13. The method of claim 11, wherein the second cutting apparatus comprises a non-rotary cutting system.

14. The method of claim 11, wherein the second cutting apparatus comprises a laser cutting system, a water jet cutting system, or a reciprocating platen cutting system.
